(19) United States
(12) Patent Application Publication
(10) Pub. No.: US 2017/0272267 A1
(43) Pub. Date: Sep. 21, 2017

(54) METHOD AND SERVER FOR COUPLING A SMART-HOME DEVICE TO A MOBILE TERMINAL

(71) Applicant: COMFYLIGHT AG, Zürich (CH)

(72) Inventor: MARCUS KÖHLER, Stauchitz (DE)

(73) Assignee: COMFYLIGHT AG, Zürich (CH)

(21) Appl. No.: 15/500,226

(22) PCT Filed: Aug. 21, 2015
(86) PCT No.: PCT/EP2015/069238

§ 371 Date: Jan. 30, 2017

(30) Foreign Application Priority Data
Aug. 21, 2014 (DE) 10 2014 216 588.1

(51) Int. Cl. H04L 12/28; H04L 12/24; H04M 1/725; H04L 29/12; H04L 12/749

(52) U.S. Cl. CPC H04L 12/2809; H04L 61/2514; H04L 45/741; H04M 1/7253; H04L 41/0809; H04L 41/0886; H04W 84/12

(57) ABSTRACT

The invention provides a method for coupling a smart home device to a mobile terminal, comprising the following features: the smart home device (10, 20, 30) is connected to a server (40) via a source NAT router (14, 24, 34); the mobile terminal (12, 22, 32) is connected to the server (40) via the same source NAT router (14, 24, 34); the server (40) compares a public network address of the smart home device (10, 20, 30) with a public network address of the mobile terminal (12, 22, 32); and where the public network addresses match, the server (40) forwards an identification feature of the smart home device (10, 20, 30) to the mobile terminal (12, 22, 32).

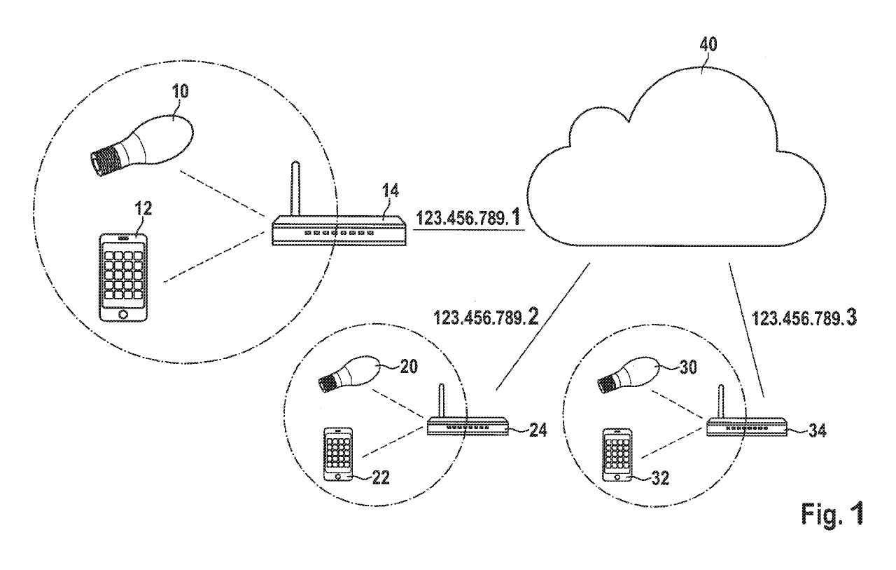

The invention also provides a corresponding server, a corresponding computer program and a corresponding storage medium.

The present invention relates to a method for coupling a smart home device to a mobile terminal. The present invention also relates to a corresponding server, to a corresponding computer program and to a corresponding storage medium.

### PRIOR ART

The keyword “smart home” is commonly used as a generic term for technical methods and systems in living spaces and homes, the focus of which is an increase in standards of living and quality of life, security or more efficient use of energy on the basis of networked and remote-controlled devices and installations, and of automated processes. In the following, it is not only domestic appliances and household devices such as lamps, shutters, radiators, cookers, refrigerators and washing machines which are to be understood as smart home devices, but also consumer electronics components, for example for the central storage of audio and video content, which can be used throughout the house. Smart home devices which are known from the prior art sometimes have their own programming interface, in addition to a network connection, which allows them to be controlled by means of mobile terminals.

### DISCLOSURE OF THE INVENTION

The invention provides a method for coupling a smart home device to a mobile terminal, a corresponding server, a corresponding computer program and a corresponding storage medium according to the independent claims.

An advantage of this solution lies in the logical association—“coupling”, as it were—which is achieved between the smart home device and a specific mobile terminal. The suggested approach does not require any intervention by the end user. The user does not have to change his WLAN network or create user accounts, nor does he have to link his phone camera with the smart home device, or enter an identification code. Instead, this is a plug-and-play solution, which allows the smart home device and the mobile terminal to be associated without any configuration.

Further advantageous embodiments of the invention are provided in the dependent claims. In a preferred embodiment, the mobile terminal can assign the identification feature to an owner and can personalise the smart home device to this owner in particular. The logical association between the smart home device and the mobile terminal is thus specified for a specific user or a specific group of users. This extension of the approach according to the invention forms the basis for jointly controlling a plurality of smart home devices and coupling them to other services of the same user.

The design of the source NAT router as a WLAN router offers further advantages. This allows the connection of the smart home device and the mobile terminal to the router to take place wirelessly. The lack of a wired connection, in particular of the smart home device, which is thereby facilitated attributes a particularly high degree of flexibility and practicability to the proposed method.

In this case, the source NAT router can be the Internet gateway of a home network. Such a network is capable of connecting the home network, which comprises the smart home device and the mobile terminal, to the Internet. Since commercially available Internet gateways often have the functionality of a source NAT router themselves, there is no need for a separate router or modem.

A media access control address or an IPv6 address of the smart home device can in particular be considered as the identification feature. Since conventional smart home devices can mostly be addressed via the data link layer (layer 2) of the OSI model, they have such an address ex works, and therefore the sometimes resource-intensive generation of an additional identification feature can be omitted in this way.

Alternatively, a universally unique identifier (UUID) of the smart home device may be used as the identification feature. A UUID of this type can, owing to its pseudo-random character, be generated by the smart home device itself without a central control unit, and can be used for identification, wherein the risk of a duplicate is negligibly low.

A smartphone may in particular be used as a mobile terminal as part of a method according to the invention. After receiving the identification feature, a smartphone of this type can control the smart home device from any location—via an available mobile communication network, for example—by means of the identification feature. The use of a smartphone in this respect therefore considerably increases the user-friendliness and acceptance of the proposed method.

### BRIEF DESCRIPTION OF THE DRAWINGS

An embodiment of the invention is shown in the drawings and is described in greater detail in the following.

The single FIGURE illustrates the use of the network address translation (NAT) as part of a method according to the invention.

### EMBODIMENTS OF THE INVENTION

The FIGURE illustrates the coupling of three smart home devices 10, 20, 30 to each of the mobile terminals 12, 22, 32 which are associated therewith according to an embodiment of the invention. The mobile terminals 12, 22, 32 are commercially available smartphones in this case, wherein each smart home device 10, 20, 30 is connected to the mobile terminal 12, 22, 32 associated therewith in another home network.

Each of the three smart home devices, 10, 20 30 is initially wirelessly connected to the source NAT router 14, 24, 34 of the home network in question. The source NAT routers 14, 24, 34, which are designed as WLAN-capable Internet gateways, transmit the respective connections via the Internet to a common server 40.

The three mobile terminals 12, 22, 32 are also wirelessly connected to the server 40 via said source NAT router 14, 24, 34. As soon as the connection of a smart home device 10, 20, 30 and the terminal 12, 22, 32 in question to the server 40 has been established, the server 40 compares the public network address of the smart home device 10, 20, 30 with that of the mobile terminal 12, 22, 32.

In the case of the first smart home device 10 and the first mobile terminal 12, both of which are connected to the server 40 via the common first source NAT router 14, the server 40 detects that the public network address 123.456.789.1 of both devices 10, 12 matches. As a result, the server 40 forwards an identification feature of the first smart home device 10 to the first mobile terminal 12. This identification feature may consist in a media access control address, IPv6 address or UUID of the first smart home device 10. However, it is also conceivable that the manufacturer in question possibly uses their own, non-standardised identification features. Further examples would be GUIDs or proprietary approaches.

Since the public network address 123.456.789.2 of the second smart home device 20 and the second mobile terminal 22, which are connected via the common second source NAT router 24, also match, the server 40 proceeds accordingly in this case. Similarly, the identification feature of the third smart home device 30 is transmitted to the third mobile terminal 32, since both devices 30, 32 share the public network address 123.456.789.3 of the third source NAT router 34.

In an optional step, the three mobile terminals 12, 22, 32 assign to an owner the identification feature transmitted to each of them and personalise the smart home device 10, 20, 30 in question accordingly. Each mobile terminal 12, 22, 32 is now capable of controlling the associated smart home device 10, 20, 30 by means of suitable application software in the form of a smartphone app.

1-9. (canceled)

10. A method for coupling a smart home device to a mobile terminal, comprising:
establishing, by a server, a connection with a smart home device via a source network address translation (NAT) router;
establishing, by the server, a connection with a mobile terminal via the source NAT router;
comparing, by the server, a public network address of the smart home device with a public network address of the mobile terminal; and
if the public network address of the smart home device matches the public network address of the mobile terminal, forwarding, by the server, an identification feature of the smart home device to the mobile terminal.

11. The method according to claim 10, wherein:
the mobile terminal assigns the identification feature to an owner; and
the mobile terminal personalizes the smart home device to the owner by name in particular.

12. The method according to claim 10, wherein:
the source NAT router is a wireless local area network (WLAN) router; and
the smart home device and the mobile terminal are wirelessly connected to the WLAN router.

13. The method according to claim 10, wherein:
the source NAT router is an Internet gateway of a home network;
the home network comprises the smart home device and the mobile terminal; and
the Internet gateway and the server are connected via the Internet.

14. The method according to claim 10, wherein the identification feature of the smart home device comprises one of a media access control address, an IPv6 address, a universally unique identifier, a globally unique identifier, or a proprietary identification feature from a manufacturer of the smart home device.

15. The method according to claim 10, wherein:
the mobile terminal is a smartphone; and
the smartphone controls the smart home device from any location via the identification feature.

16. A server configured for coupling a smart home device to a mobile terminal, the server comprising:
a means for connecting a smart home device to the server via a source network address translation (NAT) router;
a means for connecting a mobile terminal to the server via the same source NAT router;
a means for comparing a public network address of the smart home device with a public network address of the mobile terminal; and
a means for forwarding an identification feature of the smart home device to the mobile terminal if the public network address of the smart home device matches the public network address of the mobile terminal.

17. The server according to claim 16, wherein:
the mobile terminal assigns the identification feature to an owner; and
the mobile terminal personalizes the smart home device to the owner by name in particular.

18. The server according to claim 16, wherein:
the source NAT router is a wireless local area network (WLAN) router; and
the smart home device and the mobile terminal are being wirelessly connected to the WLAN router.

19. The server according to claim 16, wherein:
the source NAT router is an Internet gateway of a home network;
the home network comprises the smart home device and the mobile terminal; and
the Internet gateway and the server are connected via the Internet.

20. The server according to claim 16, wherein the identification feature of the smart home device comprises one of a media access control address, an IPv6 address, a universally unique identifier, a globally unique identifier, or a proprietary identification feature from a manufacturer of the smart home device.

21. The server according to claim 16, wherein:
the mobile terminal is a smartphone; and
the smartphone controls the smart home device from any location via the identification feature.

22. A non-transitory computer-readable medium embodying program code for coupling a smart home device to a mobile terminal, the program code comprising instructions which, when executed by a processor included in a server, cause the processor to perform operations comprising:
connecting the server to the smart home device via a source network address translation (NAT) router;
connecting the server to the mobile terminal via the same source NAT router;
comparing, by the server, a public network address of the smart home device with a public network address of the mobile terminal; and
if the public network address of the smart home device matches the public network address of the mobile terminal, forwarding, by the server, an identification feature of the smart home device to the mobile terminal.

23. The non-transitory computer-readable medium according to claim 22, wherein:
the source NAT router is a wireless local area network (WLAN) router; and
the smart home device and the mobile terminal are being wirelessly connected to the WLAN router.

24. The non-transitory computer-readable medium according to claim 22, wherein:
the source NAT router is an Internet gateway of a home network;
the home network comprises the smart home device and the mobile terminal; and
the Internet gateway and the server are connected via the Internet.

25. The non-transitory computer-readable medium according to claim 22, wherein the identification feature of the smart home device comprises one of a media access control address, an IPv6 address, a universally unique identifier, a globally unique identifier, or a proprietary identification feature from a manufacturer of the smart home device.

26. The non-transitory computer-readable medium according to claim 22, wherein:
the mobile terminal is a smartphone; and
the smartphone controls the smart home device from any location via the identification feature.
